(19) United States
(12) Patent Application Publication
(10) Pub. No.: US 2013/0094915 A1
(43) Pub. Date: Apr. 18, 2013

(54) POSITIONING SLEEVE FOR ELECTRICAL DRILL DUST COLLECTOR AND ELECTRICAL DRILL DUST COLLECTOR USING THE POSITIONING SLEEVE

(71) Applicant: Chao-Yang Chen, New Taipei City 234 (TW)

(72) Inventor: Chao-Yang Chen, New Taipei City 234 (TW)

(21) Appl. No.: 13/805,105

(22) PCT Filed: Apr. 23, 2012
(86) PCT No.: PCT/CN2012/000547

§ 371 Date: Dec. 18, 2012

(30) Foreign Application Priority Data
Apr. 22, 2011 (CN) 201120120627.2
Oct. 28, 2011 (CN) 201110333433.5

(51) Int. Cl. B23Q 11/00; F16B 1/00

(52) U.S. Cl. CPC B23Q 11/0071; F16B 1/00
USPC 408/67; 403/336

(57) ABSTRACT

The invention relates to a positioning sleeve for an electrical drill dust collector and an electrical drill dust collector using the positioning sleeve. The positioning sleeve comprises: a sleeve portion coupled with a flange at a front edge of an electrical drill and a support body forward extended from the sleeve portion, surrounding and isolating a rotated portion of the electrical drill to enhance the drill operating safety. The electrical drill dust collector using the aforesaid positioning sleeve comprises: a fixing base fixing on the support body, a telescoping sleeve having a ring body at an front end thereof, a dust collection section at a front end section thereof and a bellows section at a tail end section thereof, and an elastic member having a positioning end connected to the fixing base and a free end thereof connected to the ring body to improve the dustproof effect.

### BACKGROUND OF THE INVENTION

1. Field of the Invention

The invention relates to a positioning sleeve for an electrical drill dust collector and an electrical drill dust collector using the positioning sleeve, and more particularly to the positioning sleeve coupled with a flange of the electrical drill as well as surrounding and isolating a rotated portion of the electrical drill and provided for coupling with an electrical drill dust collector.

2. Description of the Related Art

While using an electrical drill, a large amount of dust flying around fills the air, not only affecting the air quality and users' breathing but resulting in unclean and untidy environment. Therefore, an electrical drill dust collector 10 as shown in FIG. 1 covers over a drill bit 22 of an electrical drill 20 and includes several bellows 11 for recovery from compression.

However, the conventional electrical drill dust collector 10 is directly positioned on the flange 21 of the electrical drill 20 so that the axial length of the overall electrical drill dust collector 10 becomes very long. As a result, when drilling, the electrical drill dust collector 10 substantially vibrates and a wall-against end of the electrical drill dust collector 10 has poor connection to the wall, reducing the dustproof effect.

### SUMMARY OF THE INVENTION

It is the first primary object of the present invention to provide a positioning sleeve for an electrical drill dust collector to increase the efficacy of the electrical drill dust collector.

It is the second object of the present invention to enhance the efficacy of the electrical drill operating safety.

It is the last object of the present invention to provide an electrical drill dust collector using the aforesaid positioning sleeve to improve the dustproof effect.

In order to achieve the above objects, the positioning sleeve of the invention comprises: a sleeve portion coupled with a flange at a front edge of an electrical drill and a support body forward extended from the sleeve portion, surrounding and isolating a rotated portion of the electrical drill and provided for coupling with a dust collector.

Further, the support body has a connecting ring body outward expanded from a front end section thereof and an internal part of the connecting ring body together with an internal part of the dust collector form a dust collection chamber wherein the connecting ring body has an air outlet connecting to the dust collection chamber, a filter net corresponding to the air outlet and an outer thread on an outer periphery thereof for screwing to the dust collector. Further, the internal part of the support body corresponding to the rotated portion of the electrical drill has a bearing and the sleeve portion coupled with the flange of the electrical drill and a resilient collar mounted between the sleeve portion and the flange for increasing tightness. Furthermore, the support body is a fencing or tubular shape and the positioning sleeve is light transmissive.

The electrical drill dust collector of the invention comprises: a sleeve portion coupled with a flange at a front edge of an electrical drill, a support body forward extended from the sleeve portion, surrounding and isolating a rotated portion of the electrical drill, and a dust collector connected to the support body and including a fixing base fixing on the support body, a telescoping sleeve having a ring body at an front end thereof, a dust collection section at a front end section thereof and a bellows section at a tail end section thereof, the ring body having a through hole for a drill bit passing through and a positioning groove for positioning an elastic member, the dust collection section connecting to the ring body and forming a hollow cone type with a narrow front and a wide back in order to have a containing space for collecting dust, the bellows section connecting to the dust collection section and forming a tubular type with a caliber smaller than a tail end of the dust collection section, a tail end of the bellows section connecting to the fixing base, and the elastic member having a positioning end connected to the fixing base and a free end thereof connected to the ring body of the telescoping sleeve.

Further, the support body has a connecting ring body outward expanded from a front end section thereof and an outer thread on an outer periphery thereof for screwing to the dust collector and the fixing base of the dust collector corresponding to the external thread of the connecting ring body has an internal thread. Furthermore, the elastic member is a spring and the positioning sleeve is light transmissive.

### BRIEF DESCRIPTION OF THE DRAWINGS

FIG. 1 is a structure schematic view of a conventional electrical drill dust collector;

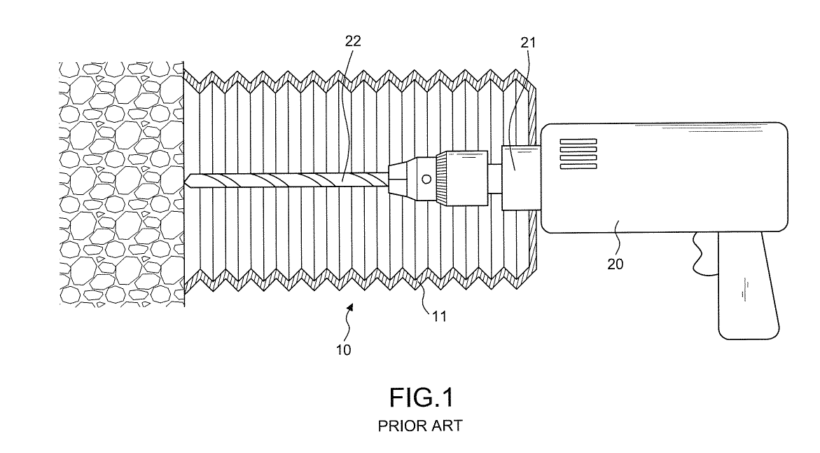

FIG. 2 is a structure perspective view of a positioning sleeve of the present invention;

FIG. 3 is a structure perspective view of a positioning sleeve from another angle in accordance with the present invention;

FIG. 4 is a structure sectional view of a positioning sleeve of the present invention;

FIG. 5 is an exploded perspective view of a positioning sleeve and an electrical drill dust collector in accordance with the present invention;

FIG. 6 is an application example of a positioning sleeve and an electrical drill dust collector in accordance with the present invention;

FIG. 7 is a structure sectional view of a positioning sleeve and an electrical drill dust collector in accordance with the present invention, illustrating before drilling; and

FIG. 8 is a structure sectional view of a positioning sleeve and an electrical drill dust collector in accordance with the present invention, illustrating while drilling.

### DETAILED DESCRIPTION OF THE PREFERRED EMBODIMENT

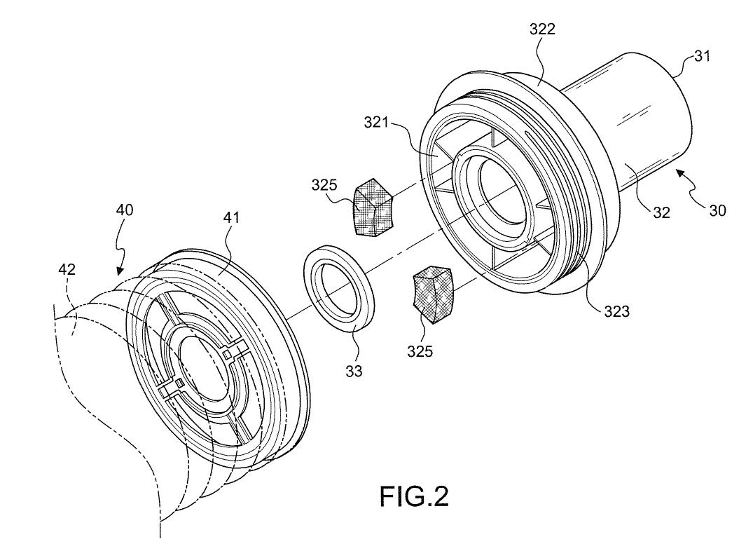

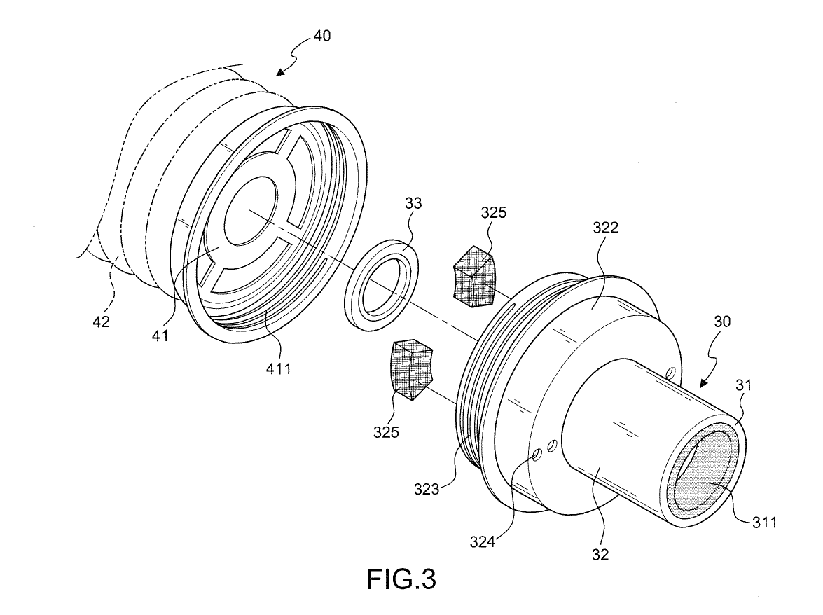

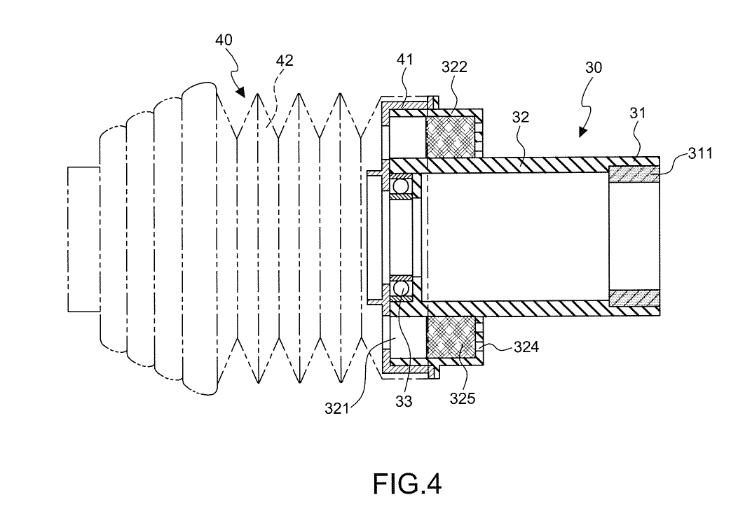

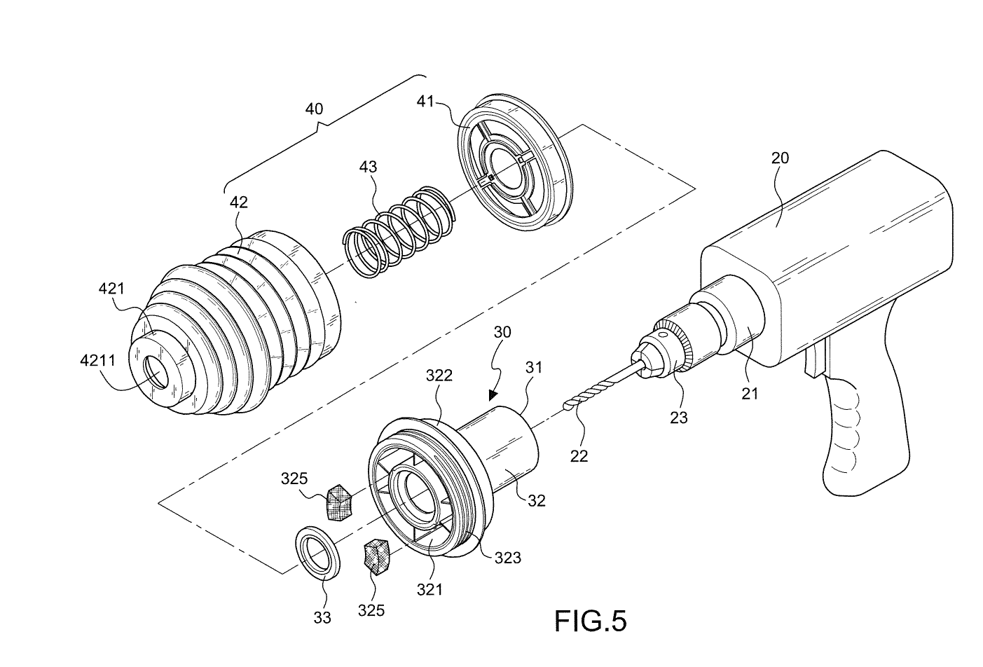

Referring to FIGS. 2 through 6, the preferred embodiment of a light transmissive positioning sleeve 30 in accordance with the present invention comprises: a sleeve portion 31 coupled with a flange 21 at a front edge of an electrical drill 20 and a resilient collar 311 may be mounted between the sleeve portion 31 and the flange 21, and a support body 32 in a fencing or tubular shape forward extended from the sleeve portion 31, surrounding and isolating a rotated portion 23 of the electrical drill 20 for being gripped by a user and provided for coupling with a dust collector 40.

Further, the internal part of the support body 32 corresponding to the rotated portion 23 of the electrical drill 20 has a bearing 33 to form a stable structure, reducing vibration. The support body 32 further has a connecting ring body 322 outward expanded from a front end section thereof. The connecting ring body 322 has an outer thread 323 on an outer periphery thereof for screwing to the dust collector 40 and an internal part together with an internal part of the dust collector 40 forming a dust collection chamber 321. The connecting ring body 322 further has an air outlet 324 connecting to the dust collection chamber 321 and a filter net 325 corresponding to the air outlet 324.

Based on the features disclosed, the arrangement of the positioning sleeve 30 shortens the length of the dust collector 40 to reduce the vibration while drilling and the wall-against end of the dust collector 40 stably abuts the wall to significantly increase the efficacy of the dust collector 40. Moreover, the rotated portion 23 of the electrical drill 20 is surrounded and isolated by the positioning sleeve 30 so that the user can directly grip on the positioning sleeve 30 to enhance the efficacy of operating safety. The dust collection chamber 321 of the present invention allows drill cutting dust to gather together while drilling, which is conductive to the follow-up of dust cleaning.

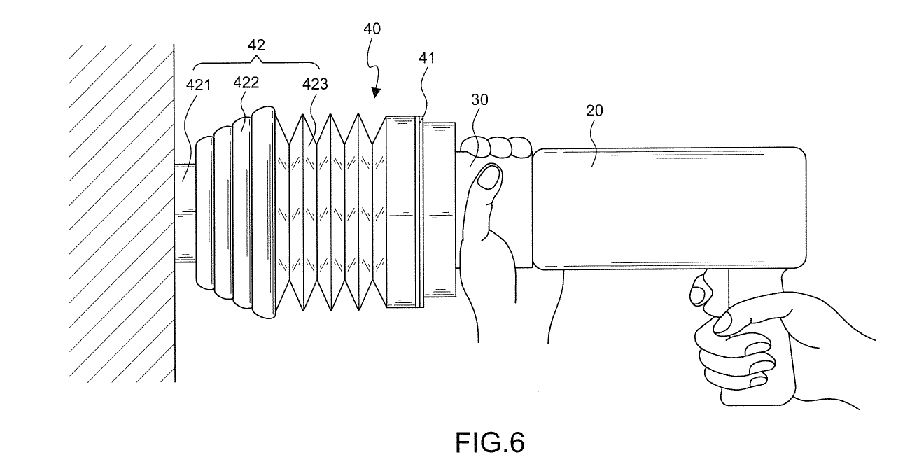

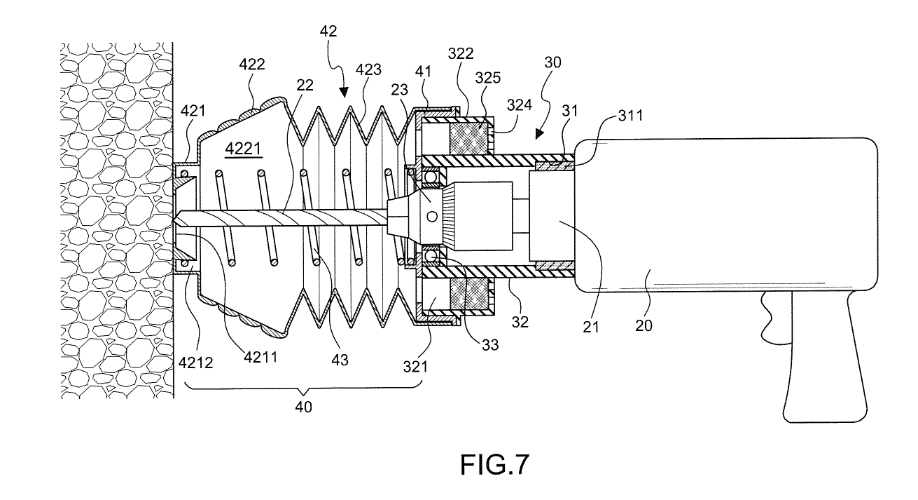

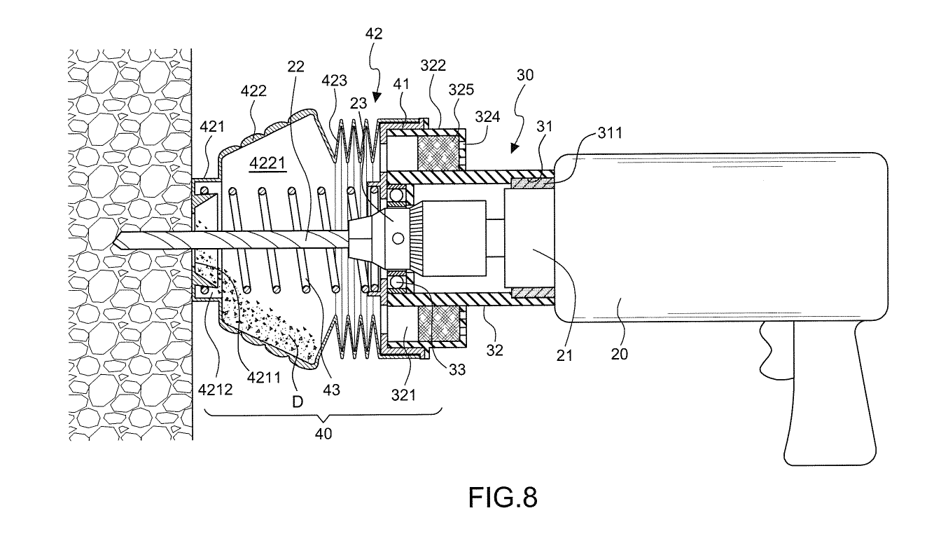

Referring to FIGS. 6 through 8, the preferred embodiment of a dust collector 40 connected to the support body 32 of the positioning sleeve 30 in accordance with the present invention comprises: a fixing base 41 corresponding to the external thread 323 of the connecting ring body 322 has an internal thread 411 for screwing with the support body 32 of the positioning sleeve 30, a light transmissive telescoping sleeve 42 axially telescoping along a drill bit 22 of the electrical drill 20 and having a ring body 421 at an front end thereof, a dust collection section 422 at a front end section thereof and a bellows section 423 at a tail end section thereof, the ring body 421 having a through hole 4211 for a drill bit 22 passing through and a positioning groove 4212 for positioning an elastic member 43, the dust collection section 422 connecting to the ring body 421 and forming a hollow cone type with a narrow front and a wide back in order to have a containing space 4221 for collecting dust D, the bellows section 423 connecting to the dust collection section 422 and forming a tubular type with a caliber smaller than a tail end of the dust collection section 422, a tail end of the bellows section 423 connecting to the fixing base 41, and the elastic member 43 such as a spring having a positioning end connected to the fixing base 41 and a free end thereof connected to the ring body 421 of the telescoping sleeve 42 for the elastic member 43 recovering to the initial state.

Although particular embodiments of the invention have been described in detail for purposes of illustration, various modifications and enhancements may be made without departing from the spirit and scope of the invention. Accordingly, the invention is not to be limited except as by the appended claims.

1. A positioning sleeve for electrical drill dust collector, comprising:
a sleeve portion coupled with a flange at a front edge of an electrical drill; and
a support body forward extended from the sleeve portion, surrounding and isolating a rotated portion of the electrical drill and provided for coupling with a dust collector.

2. The positioning sleeve for electrical drill dust collector as claimed in claim 1, wherein the support body has a connecting ring body outward expanded from a front end section thereof and an internal part of the connecting ring body together with an internal part of the dust collector form a dust collection chamber.

3. The positioning sleeve for electrical drill dust collector as claimed in claim 2, wherein the connecting ring body has an air outlet connecting to the dust collection chamber and a filter net corresponding to the air outlet.

4. The positioning sleeve for electrical drill dust collector as claimed in claim 3, the connecting ring body has an outer thread on an outer periphery thereof for screwing to the dust collector.

5. The positioning sleeve for electrical drill dust collector as claimed in claims 4, wherein the internal part of the support body corresponding to the rotated portion of the electrical drill has a bearing.

6. The positioning sleeve for electrical drill dust collector as claimed in claim 5, wherein the sleeve portion coupled with the flange of the electrical drill and a resilient collar mounted between the sleeve portion and the flange for increasing tightness.

7. The positioning sleeve for electrical drill dust collector as claimed in claim 6, wherein the support body is a fencing or tubular shape and the positioning sleeve is light transmissive.

8. An electrical drill dust collector using the positioning sleeve as claimed in claim 1, comprising:
a sleeve portion coupled with a flange at a front edge of an electrical drill;
a support body forward extended from the sleeve portion, surrounding and isolating a rotated portion of the electrical drill; and
a dust collector connected to the support body and including a fixing base fixing on the support body, a telescoping sleeve having a ring body at an front end thereof, a dust collection section at a front end section thereof and a bellows section at a tail end section thereof, the ring body having a through hole for a drill bit passing through and a positioning groove for positioning an elastic member, the dust collection section connecting to the ring body and forming a hollow cone type with a narrow front and a wide back in order to have a containing space for collecting dust, the bellows section connecting to the dust collection section and forming a tubular type with a caliber smaller than a tail end of the dust collection section, a tail end of the bellows section connecting to the fixing base, and the elastic member having a positioning end connected to the fixing base and a free end thereof connected to the ring body of the telescoping sleeve.

9. The electrical drill dust collector using the positioning sleeve as claimed in claim 8, wherein the support body has a connecting ring body outward expanded from a front end section thereof and an outer thread on an outer periphery thereof for screwing to the dust collector and the fixing base of the dust collector corresponding to the external thread of the connecting ring body has an internal thread.

10. The electrical drill dust collector using the positioning sleeve as claimed in claim 9, wherein the elastic member is a spring and the positioning sleeve is light transmissive.
